(19) United States
(12) Patent Application Publication
(10) Pub. No.: US 2009/0229426 A1
(43) Pub. Date: Sep. 17, 2009

(54) OPEN-END WRENCH

(76) Inventor: Arthur Wu, Shen Kang Hsiang (TW)

Correspondence Address: Dr. BANGER SHIA;Int''l Patent Office of Bang Shia, 102 Lindencrest Ct, Sugar Land, TX, 77479-5201, US

(21) Appl. No.: 12/211,810

(22) Filed: Sep. 16, 2008

Related U.S. Application Data
(63) Continuation of application No. 11/707,960, filed on Feb. 20, 2007, now abandoned.

(51) Int. Cl. B25B 13/08

(52) U.S. Cl. 81/121.1

(57) ABSTRACT

A wrench includes a handle and an open-end with two jaws and each jaw has a driving surface. Each driving surface has a contacting area and two yielding areas. The contacting area is located between the two yielding areas and includes a contact portion and two notches. The contact portion is located between the two notches, and two extension areas each are connected between the yielding area and the notch corresponding thereto. A corner is formed at a joint area of the contact portion and an inside of the notch so as to bite a rounded fastener head. The contact portions are matched with straight sides of a normal fastener head.

### FIELD OF THE INVENTION

This application is a Continuation Application of previously U.S. application Ser. No. 11/707,960, and claims the priority of the filing date of Feb. 20, 2007, and claims 1-8 in the current Continuation Application correspond to claims 1-8 in the parent application, respectively, and are entitled to the parent application's filing date of Feb. 20, 2007.

### BACKGROUND OF THE INVENTION

### Description of the Prior Art

As shown in FIG. 5, an open-end wrench disclosed in U.S. Design Pat. No. 363,010 has an open-end driving head including two jaw clips, and the maximum width W1 between outer edges of the two jaw clips and the mouth width S1 of the two jaw clips are different from the international specification so that the two jaws of the open-end wrench have the wide outer edge. Overall, the mouth width S1 is slightly smaller than the normal width between the outer edges of the two jaws of the open-end wrench so that the wrench can advantageously reach the narrower inverse-U shaped operation environment, which cannot be reached by the open-end wrench having the international standard size, to clip the nut.

The open-end wrench of FIG. 5 has the features that the maximum width W1 between the outer edges of the two jaws, and that the mouse width S1 between the two jaw clips to provide the advanced and enhanced effects. However, this type of structure is not the best structure having the best golden ratio. The subject of this technology can be clearly seen from FIG. 5. Due to the special ratio of W1 to S, the two jaw clips of the open-end wrench have the convex middle sections and the converged upper and lower sections to form the semi-circular jaw clips. The semi-circular jaw clips can be smoothly inserted into the narrow inverse-U shaped space to clip the nut. However, when the wrench is rotated to release the nut, the space for wrenching is limited because the semi-circular jaw clips have the convex middle sections (the wall thickness of the middle section is far greater than the wall thicknesses of the upper and lower sections). So, the wrench has to be taken out and placed into the space to wrench for many times repeatedly in order to achieve the object of screwing or unscrewing the nut, and the operation utility is insufficient.

Furthermore, the proportional design of the open-end wrench of FIG. 5 defines the smaller widths of the upper and lower sections of the two jaw clips to form the converging semi-circular jaw clips. The typical open-end wrench has a stress concentration portion located at the corner positions E of the jaw clips when the wrench is wrenching the nut. The corner position E corresponds to the outer position F, which is just the junction between the open-end driving head and the handle. Either the molded metal or the molded non-metal has the common property regardless of the molding method. That is, the stress concentration further occurs at the corner (especially the tip angle). So, the portion E has the weakest structure due to the smaller wall thickness and the stress concentration portion, and tends to broken during the operating procedure. However, as shown in FIG. 5, the width T3 (the distance between the corner position E to the outer position F) of the stress region of the open-end wrench structure is far smaller than the jaw width T4 of the middle section of the jaw clips (the portion passed by the transversal center line G of the driving head). The maximum width W1 between the outer edges of the two jaw clips and the mouth width S1 of the two jaw clips in the open-end wrench enable the wrench to be inserted into the inverse-U shaped operation environment, which cannot be reached by the wrench having the international standard specification, but also induce the drawback of breaking the structure caused by the too-large operating force because the width T3 of the junction between the handle and the open-end driving head having the concentrated stress is smaller than the jaw width T4 of the jaw clips when the open-end wrench is wrenching the nut.

### SUMMARY OF THE INVENTION

The invention mainly provides an open-end wrench, which has jaw clips, can be smoothly inserted into the limited space to clip the nut, and can be wrenched greatly.

Another object of the invention is to provide an open-end wrench having the structure of jaw clips and the high structure rigidity.

The invention achieves the above-identified objects by providing an open-end wrench having an open-end driving head having two sides extended with first and second jaw clips. The maximum width W between outer edges of the two jaw clips may be 130 to 180%, 130 to 160%, or 130 to 156% of the mouth width S between opposite jaw end surfaces of the jaw clips. In addition, a stress region width T1 between the inner corner of the jaw end surface of the jaw clip and the outer end surface of the jaw clip is greater than a jaw width T2, which is defined as a length of a transversal phantom center line from the jaw end surface of the jaw clip to the outer edge of the jaw clip. Thus, the prior art problems of the open-end wrench technology can be overcome and the above-mentioned effects can be achieved.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial exterior view showing an open-end driving head of an open-end wrench according to the invention.

FIG. 2 is a schematic top view showing the open-end driving head of the open-end wrench according to the invention.

FIG. 3 is a schematic illustration showing that the open-end driving head of the open-end wrench of the invention is inserted into an inverse-U shaped space to clip the nut.

FIG. 4 is a schematic illustration showing a wrenching operation corresponding to FIG. 3.

FIG. 5 shows an open-end wrench disclosed in U.S. Design Pat. No. 363,010.

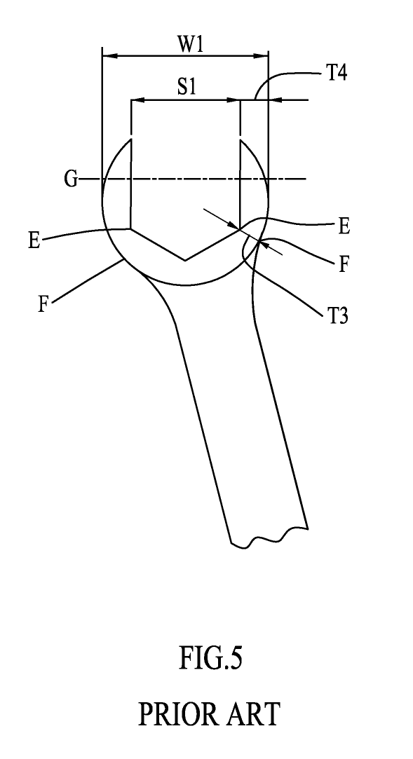

### DETAILED DESCRIPTION OF THE PREFERRED EMBODIMENTS

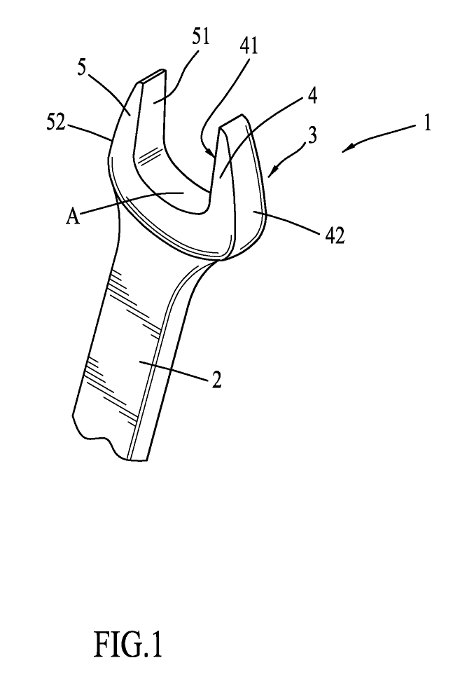

FIG. 1 shows a jaw clip structure of an open-end wrench according to the invention. As shown in FIG. 1, the open-end wrench 1 has a handle 2, an open-end driving head 3 disposed at least one end of the handle 2, and a first jaw clip 4 and a second jaw clip 5 extending from two sides of the open-end driving head 3. Inner sides of the two jaw clips face each other and are formed with jaw end surfaces 41 and 51. The two jaw end surfaces 41 and 51 are connected together through an arced connection end surface A. The outer sides of the two jaw clips are formed with sloped curved surfaces 42 and 52, which are diverged from an open end to the handle so as to form the cone-like first jaw clip 4 and the cone-like second jaw clip 5 and thus to form a narrower front portion and a wider rear portion.

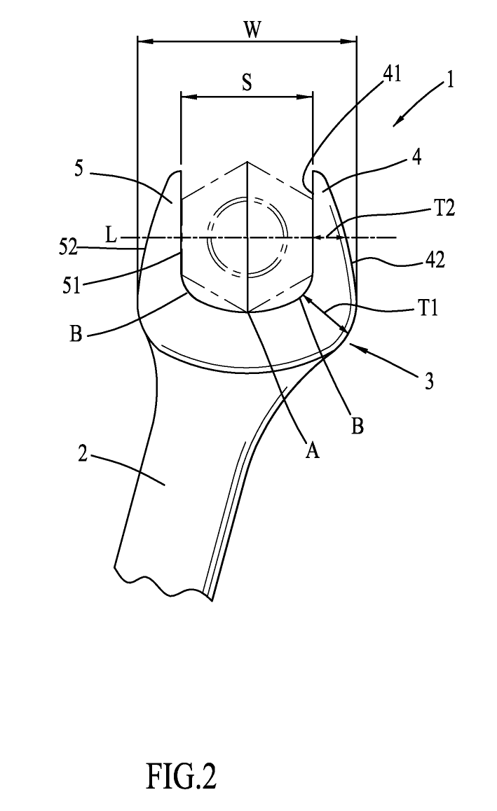

The main feature of the invention resides in the proportional design of the two jaw clips of the open-end wrench 1, as shown in FIG. 2. A maximum rim between the outer side of the first jaw clip 4 and the outer side of the second jaw clip 5 in the open-end driving head 3 is defined as a maximum width W between the outer edges of the two jaw clips. A width between the opposite jaw end surfaces 41 and 51 of the two jaw clips is defined as a mouth width S. Also, the jaw end surfaces 41 and 51 and the connection end surface A define an inner corner B. A maximum length from the inner corner B to a most protrudent portion of the sloped curved surface on the outer side of the jaw clip is defined as a stress region width T1. A transversal phantom center line L passing through the two jaw end surfaces 41 and 51 of the two jaw clips 4 and 5 at middles of nut clipping surfaces of the jaw clips is defined. A length of the transversal phantom center line L from one of the jaw end surfaces of the jaw clips to the outer edge of the jaw clip is defined as a jaw width T2. The maximum width W is 130 to 180%, 130 to 160%, 130 to 156% or 130 to 148% of the mouth width S to have the best proportional design.

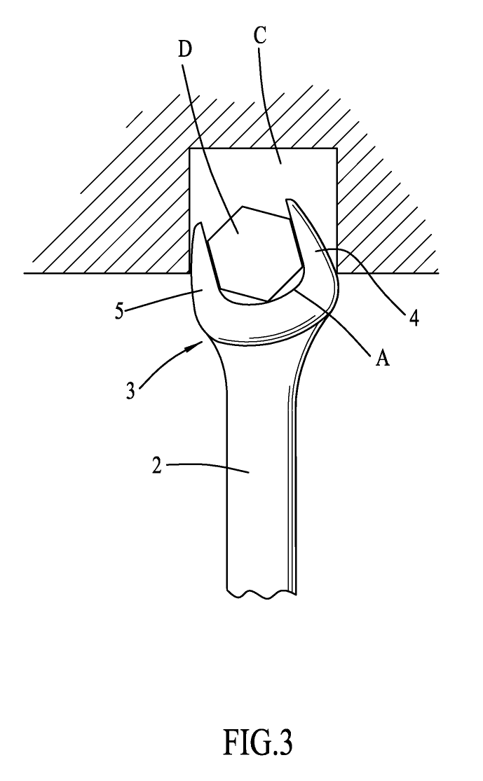

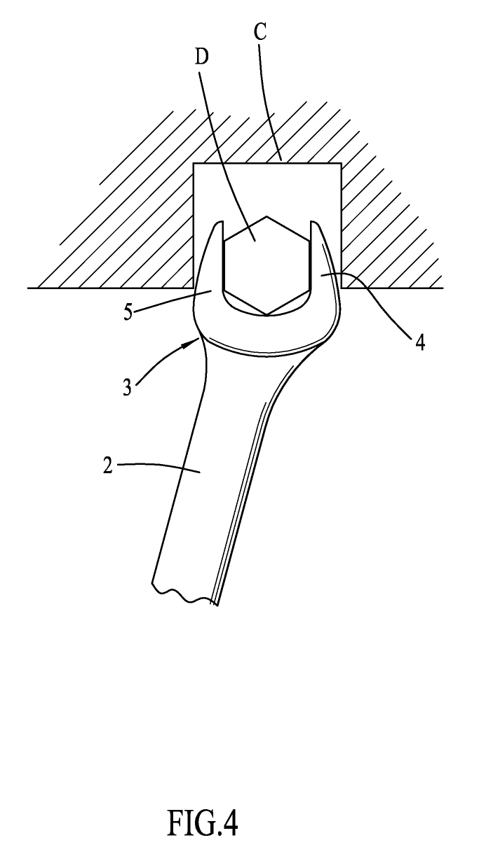

Compared the two jaw clips 4 and 5 of the open-end wrench 1 formed according to the ratio of W to S and the balanced design with the typical open-end wrench formed according to the international standard, the maximum width between the outer edges of the two jaw clips is small. So, the wrench may be inserted into the narrow inverse-U shaped space C smoothly to clip the hex nut D, as shown in FIG. 3. Meanwhile, according to the four golden ratios of the maximum width W to the mouth width S in conjunction with the cone-like jaw clip having the narrower front portion and the wider rear portion, the wrench can be greatly wrenched in the limited space when the open-end driving head 3 is inserted into the inverse-U shaped space C, as shown in FIG. 4. Thus, the number of times the open-end wrench 1 in the narrow inverse-U shaped space C has to wrench the nut D can be reduced so that the excellent operating efficiency of the open-end wrench 1 can be obtained in the limited space.

Furthermore, the jaw clips 4 and 5 of the open-end wrench 1 of the invention have the four proportional designs each having the ratio of the maximum width W to the mouth width S to make the stress region width T1 be greater than the jaw width T2 when the open-end driving head 3 is screwing or unscrewing the nut D. Thus, the open-end wrench 1 has the effect of greatly wrenching operations in the limited space. Also, the stress region width T1 is greater than the jaw width T2 in response to the condition when the nut D forces the jaw clips can really reinforce the structure intensity of the open-end wrench 1 so that the larger wrenching torque can be applied.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An open-end wrench, comprising:
a handle having at least one end formed with an open-end driving head; and
first and second jaw clips extending from two sides of the open-end driving head, wherein the jaw clips face each other and are formed with jaw end surfaces and a connection end surface for connecting the jaw end surfaces of the two jaw clips together, wherein
the connection end surface is a continuously arcuate surface, and is opposite to an open end of the open-end driving head;
a maximum width between outer edges of the two jaw clips is defined as W;
a mouth width between the opposite jaw end surfaces of the two jaw clips is defined as S;
a distance from an inner corner at a junction between one of the jaw end surfaces and the connection end surface to an outer end surface of the jaw clip is defined as a stress region width T1;
a transversal phantom center line passing through the two jaw end surfaces of the two jaw clips at middles of nut clipping surfaces of the jaw clips is defined;
a length of the transversal phantom center line from one of the jaw end surfaces of the jaw clips to the outer edge of the jaw clip is defined as a jaw width T2; and
the maximum width W is 130 to 180% of the mouth width S, and the stress region width T1 is greater than the jaw width T2; wherein
the maximum width between the outer edges of the two jaw clips is small, the wrench having the high structure rigidity allows to be inserted into a narrow limited space to clip a nut, and according to the golden ratios of the maximum width W to the mouth width S in conjunction with the cone-like jaw clip having the narrower front portion and the wider rear portion, the wrench can be greatly wrenched in the limited space when the open-end driving head is inserted into the limited space, and the wrenched times of the nut by the open-end wrench in the limited space can be reduced.

2. An open-end wrench, comprising:
a handle having at least one end formed with an open-end driving head; and first and second jaw clips extending from two sides of the open-end driving head, wherein the jaw clips face each other and are formed with jaw end surfaces and a connection end surface for connecting the jaw end surfaces of the two jaw clips together, wherein
the connection end surface is a continuously arcuate surface, and is opposite to an open end of the open-end driving head;
a maximum width between outer edges of the two jaw clips is defined as W;
a mouth width between the opposite jaw end surfaces of the two jaw clips is defined as S;
a distance from an inner corner at a junction between one of the jaw end surfaces and the connection end surface to an outer end surface of the jaw clip is defined as a stress region width T1;
a transversal phantom center line passing through the two jaw end surfaces of the two jaw clips at middles of nut clipping surfaces of the jaw clips is defined;
a length of the transversal phantom center line from one of the jaw end surfaces of the jaw clips to the outer edge of the jaw clip is defined as a jaw width T2; and
the maximum width W is 130 to 160% of the mouth width S, and the stress region width T1 is greater than the jaw width T2; wherein
the maximum width between the outer edges of the two jaw clips is small, the wrench having the high structure rigidity allows to be inserted into a narrow limited space to clip a nut, and according to the golden ratios of the maximum width W to the mouth width S in conjunction with the cone-like jaw clip having the narrower front portion and the wider rear portion, the wrench can be greatly wrenched in the limited space when the open-end driving head is inserted into the limited space, and the wrenched times of the nut by the open-end wrench in the limited space can be reduced.

3. An open-end wrench, comprising:
a handle having at least one end formed with an open-end driving head; and
first and second jaw clips extending from two sides of the open-end driving head, wherein the jaw clips face each other and are formed with jaw end surfaces and a connection end surface for connecting the jaw end surfaces of the two jaw clips together, wherein
the connection end surface is a continuously arcuate surface, and is opposite to an open end of the open-end driving head;
a maximum width between outer edges of the two jaw clips is defined as W;
a mouth width between the opposite jaw end surfaces of the two jaw clips is defined as S;
a distance from an inner corner at a junction between one of the jaw end surfaces and the connection end surface to an outer end surface of the jaw clip is defined as a stress region width T1;
a transversal phantom center line passing through the two jaw end surfaces of the two jaw clips at middles of nut clipping surfaces of the jaw clips is defined;
a length of the transversal phantom center line from one of the jaw end surfaces of the jaw clips to the outer edge of the jaw clip is defined as a jaw width T2; and
the maximum width W is 130 to 156% of the mouth width S, and the stress region width T1 is greater than the jaw width T2; wherein
the maximum width between the outer edges of the two jaw clips is small, the wrench having the high structure rigidity allows to be inserted into a narrow limited space to clip a nut, and according to the golden ratios of the maximum width W to the mouth width S in conjunction with the cone-like jaw clip having the narrower front portion and the wider rear portion, the wrench can be greatly wrenched in the limited space when the open-end driving head is inserted into the limited space, and the wrenched times of the nut by the open-end wrench in the limited space can be reduced.

4. An open-end wrench, comprising:
a handle having at least one end formed with an open-end driving head; and
first and second jaw clips extending from two sides of the open-end driving head, wherein the jaw clips face each other and are formed with jaw end surfaces and a connection end surface for connecting the jaw end surfaces of the two jaw clips together, wherein:
the connection end surface is a continuously arcuate surface, and is opposite to an open end of the open-end driving head;
a maximum width between outer edges of the two jaw clips is defined as W;
a mouth width between the opposite jaw end surfaces of the two jaw clips is defined as S;
a distance from an inner corner at a junction between one of the jaw end surfaces and the connection end surface to an outer end surface of the jaw clip is defined as a stress region width T1; a transversal phantom center line passing through the two jaw end surfaces of the two jaw clips at middles of nut clipping surfaces of the jaw clips is defined;
a length of the transversal phantom center line from one of the jaw end surfaces of the jaw clips to the outer edge of the jaw clip is defined as a jaw width T2; and
the maximum width W is 130 to 148% of the mouth width S, and the stress region width T1 is greater than the jaw width T2 wherein the maximum width between the outer edges of the two jaw clips is small, the wrench having the high structure rigidity allows to be inserted into a narrow limited space to clip a nut, and according to the golden ratios of the maximum width W to the mouth width S in conjunction with the cone-like jaw clip having the narrower front portion and the wider rear portion, the wrench can be greatly wrenched in the limited space when the open-end driving head is inserted into the limited space, and the wrenched times of the nut by the open-end wrench in the limited space can be reduced.

5. The open-end wrench according to claim 1, wherein the outer edges of the first and second jaw clips form sloped curved surfaces diverging from open ends to the handle so as to form cone-like first and second jaw clips each having a narrower front portion and a wider rear portion.

6. The open-end wrench according to claim 2, wherein the outer edges of the first and second jaw clips form sloped curved surfaces diverging from open ends to the handle so as to form cone-like first and second jaw clips each having a narrower front portion and a wider rear portion.

7. The open-end wrench according to claim 3, wherein the outer edges of the first and second jaw clips form sloped curved surfaces diverging from open ends to the handle so as to form cone-like first and second jaw clips each having a narrower front portion and a wider rear portion.

8. The open-end wrench according to claim 4, wherein the outer edges of the first and second jaw clips form sloped curved surfaces diverging from open ends to the handle so as to form cone-like first and second jaw clips each having a narrower front portion and a wider rear portion.
